(19) United States
(12) Patent Application Publication
(10) Pub. No.: US 2017/0117679 A1
(43) Pub. Date: Apr. 27, 2017

(54) AIR COOLING TYPE LASER DIODE PUMPED CHAMBER

(71) Applicant: AGENCY FOR DEFENSE DEVELOPMENT, Daejeon (KR)

(72) Inventors: Jae Hwan LEE, Daejeon (KR); Yeon Chul HA, Daejeon (KR); Kangin LEE, Daejeon (KR); Yeojeong YOON, Daejeon (KR); Jungsoo LEE, Daejeon (KR); Joonyong CHO, Daejeon (KR)

(21) Appl. No.: 15/145,939

(22) Filed: May 4, 2016

(30) Foreign Application Priority Data
Oct. 23, 2015 (KR) 10-2015-0148229

(51) Int. Cl. H01S 3/04; H01S 3/0941

(52) U.S. Cl. CPC H01S 3/0404; H01S 3/0941; H01S 3/0405

(57) ABSTRACT

An air cooling type laser diode pumped chamber includes: a laser diode portion configured to emit an excitation beam toward a plurality of different directions; a laser gain medium disposed to face the laser diode portion, so as to generate laser beam by absorbing the excitation beam emitted from the laser diode portion; a gain medium mounting portion configured to fix the laser gain medium in a state where a region of the laser gain medium to absorb the excitation beam is exposed, and configured to receive and emit heat generated from the laser gain medium to the outside by an air cooling method; and a laser diode mounting portion configured to fix the laser diode portion, and configured to receive and emit heat generated from the laser diode portion to the outside by an air cooling method.

### CROSS-REFERENCE TO RELATED APPLICATION

Pursuant to 35 U.S.C. §119(a), this application claims the benefit of earlier filing date and right of priority to Korean Application No. 10-2015-0148229, filed on Oct. 23, 2015, the contents of which is incorporated by reference herein in its entirety.

### BACKGROUND OF THE INVENTION

1. Field of the Invention

The present invention relates to an air cooling type laser diode pumped chamber using a laser diode.

2. Background of the Invention

A laser diode excitation solid-state laser has high electro-optic conversion efficiency as an emission spectrum of a laser diode is consistent with an absorption spectrum of a laser gain medium. Further, the laser diode excitation solid-state laser has a long lifespan of a laser diode (more than 100,000 hours). Owing to such advantages, the laser diode excitation solid-state laser has been constantly developed in various industrial and military fields, for a laser marking/cutting apparatus, a pollutants (contaminants) detecting apparatus, a nondestructive inspecting apparatus, a laser target designation apparatus, a distance measuring apparatus, etc.

However, the laser diode excitation solid-state laser requires a cooling water circulation apparatus having a large thermal capacity, in order to prevent a change of an emission spectrum and a decrease of an emission cross section, due to heat generated when a laser diode is driven. However, such a cooling water circulation apparatus may cause a large volume of a laser apparatus, water leakage, etc., resulting in pollution of the laser apparatus. Further, due to a high absorption coefficient of a gain medium, absorption of an excitation beam on a partial region causes distortion of laser beams and damage of the gain medium. This may lower laser performance.

Accordingly, may be considered a laser diode excitation chamber capable of stably maintaining a temperature of a laser diode and capable of increasing a distribution area of an excitation beam, without increasing a volume of a laser apparatus

### SUMMARY OF THE INVENTION

Therefore, an aspect of the detailed description is to provide an air cooling type laser diode pumped chamber capable of effectively executing a cooling operation and increasing a distribution area of an excitation beam, without an additional cooling water circulation apparatus.

To achieve these and other advantages and in accordance with the purpose of this specification, as embodied and broadly described herein, there is provided an air cooling type laser diode pumped chamber, including: a laser diode portion configured to emit an excitation beam toward a plurality of different directions; a laser gain medium disposed to face the laser diode portion, so as to generate laser beam by absorbing the excitation beam emitted from the laser diode portion; a gain medium mounting portion configured to fix the laser gain medium in a state where a region of the laser gain medium to absorb the excitation beam is exposed, and configured to receive and emit heat generated from the laser gain medium to the outside by an air cooling method; and a laser diode mounting portion configured to fix the laser diode portion, and configured to emit heat generated from the laser diode portion to the outside by an air cooling method.

In an embodiment of the present invention, the laser gain medium may include: a first part having one exposed region; and a second part having another exposed region crossing the first part in a symmetrical manner. The laser diode portion may include: a first laser diode configured to emit the excitation beam toward the first part; and a second laser diode configured to emit the excitation beam toward the second part.

In an embodiment of the present invention, the gain medium mounting portion may include a reflector configured to reflect the excitation beam emitted from the laser diode portion toward the laser gain medium, and thus to absorb the excitation beam to the laser gain medium, the reflector disposed close to the laser gain medium and formed of a material from which the excitation beam having passed through the laser gain medium can be reflected.

In an embodiment of the present invention, the reflector may be provided with a scattered reflection layer formed of a scattered reflection-processed material such that the excitation beam is reflected in a diffused manner.

In an embodiment of the present invention, the air cooling type laser diode pumped chamber may further include a thermo-element configured to have temperature decrease on its one surface and to have temperature increase on its another surface when an electric current is applied thereto. The thermo-element may be disposed such that the laser diode portion and the laser gain medium are positioned on the one surface, such that heat generated from the laser diode portion and the laser gain medium may be cooled.

In an embodiment of the present invention, at least one of the gain medium mounting portion and the laser diode mounting portion may be provided with radiating fins formed on an outer surface thereof so as to increase a contact area with external air.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a perspective view illustrating an assembled state of an air cooling type laser diode pumped chamber according to an embodiment of the present invention;

FIG. 2 is a perspective view illustrating a disassembled state of the air cooling type laser diode pumped chamber shown in FIG. 1;

FIG. 3 is a perspective view illustrating a gain medium mounting portion shown in FIG. 2;

FIG. 4 is a perspective view illustrating a laser diode mounting portion shown in FIG. 2;

FIG. 5A is a view illustrating a distribution of an excitation beam absorbed by the laser gain medium 120 shown in FIG. 2, during four-surface excitation;

FIG. 5B is a view illustrating a distribution of a computer simulated excitation beam absorbed by the laser gain medium 120 shown in FIG. 2, during four-surface excitation;

FIG. 5C is a view illustrating a distribution of an excitation beam absorbed by the laser gain medium 120 shown in FIG. 2, during left two-surface excitation;

FIG. 5D is a view illustrating a distribution of an excitation beam absorbed by the laser gain medium 120 shown in FIG. 2, during right two-surface excitation; and

FIG. 6 is a graph illustrating an output energy of a laser formed by the air cooling type laser diode pumped chamber shown in FIG. 1.

### DETAILED DESCRIPTION OF THE INVENTION

Description will now be given in detail of preferred configurations of an air cooling type laser diode pumped chamber according to the present invention, with reference to the accompanying drawings.

For the sake of brief description with reference to the drawings, the same or equivalent components may be provided with the same or similar reference numbers, and description thereof will not be repeated. A singular representation may include a plural representation unless it represents a definitely different meaning from the context.

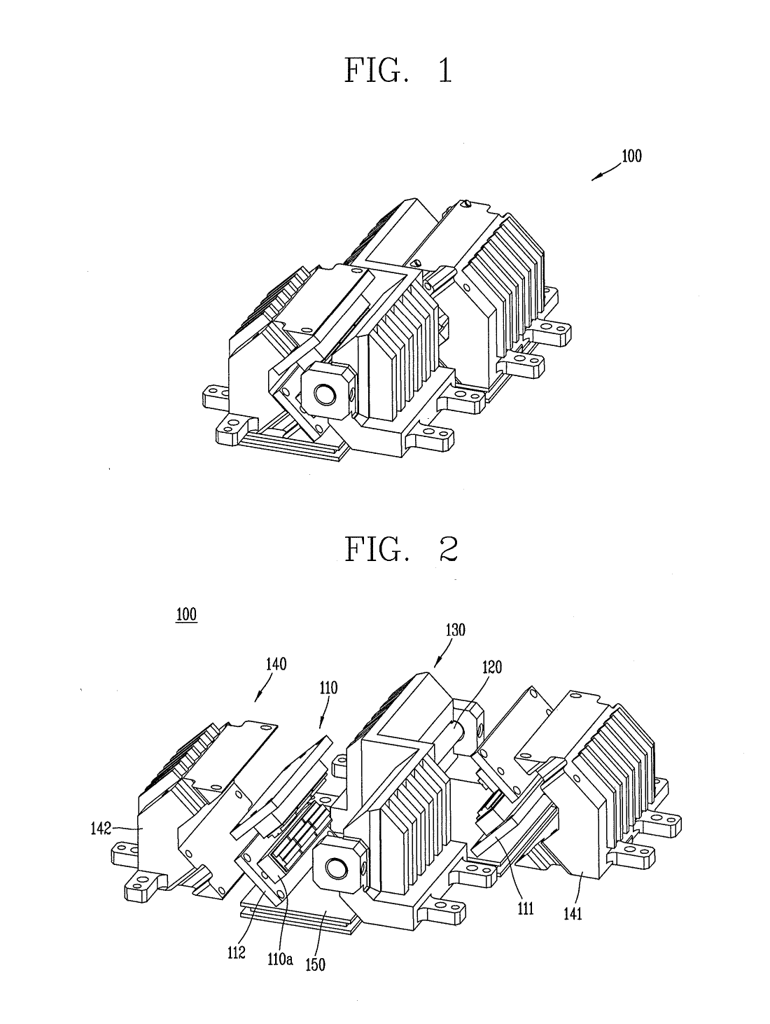

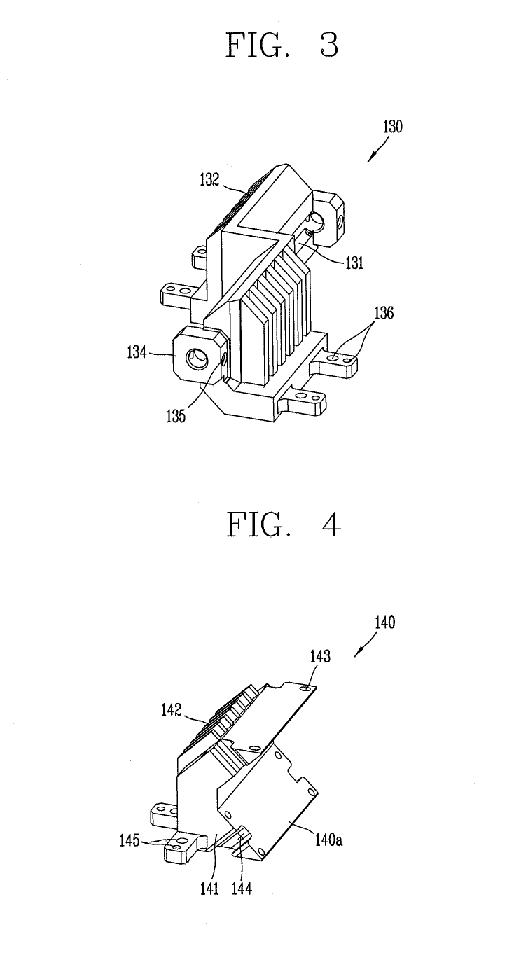

FIG. 1 is a perspective view illustrating an assembled state of an air cooling type laser diode pumped chamber 100 according to an embodiment of the present invention. FIG. 2 is a perspective view illustrating a disassembled state of the air cooling type laser diode pumped chamber 100 shown in FIG. 1. FIG. 3 is a perspective view illustrating a gain medium mounting portion 130 shown in FIG. 2. FIG. 4 is a perspective view illustrating a laser diode mounting portion 140 shown in FIG. 2.

Referring to FIGS. 1 to 4, the air cooling type laser diode pumped chamber 100 includes a laser diode portion 110, a laser gain medium 120, a gain medium mounting portion 130, and a laser diode mounting portion 140.

The laser diode portion 110 is configured to emit an excitation beam toward a plurality of directions. For instance, as shown in FIG. 2, the laser diode portion 110 may be formed to have laser diodes 110a on its two surfaces which form an included (contained) angle therebetween. The included angle may be formed to have its size controllable, thereby enhancing beam quality. The laser diode portion 110 is not limited to the one shown in the drawings. That is, the mounting position of the laser diodes 110a and the number of the laser diodes 110a may be modified in various manners.

The laser diode portion 110 may select a specific wavelength, a multi-wavelength, or a line width more than 3 nm, so as to be less sensitive to a temperature change of the outside. In order to prevent contamination of the laser diode portion 110, the laser diode portion 110 may be disposed in a vacuum state or in a housing filled with nitrogen. Alternatively, a cover (not shown) for covering the laser diode portion 110 may be additionally provided.

The laser gain medium 120 is disposed to face the laser diode portion 110 so as to generate laser beam by absorbing an excitation beam emitted from the laser diode portion 110. For instance, as shown, the laser gain medium 120 may have a cylindrical rod shape which is long extended to one direction.

The laser gain medium 120 may include a first part (not shown) having one exposed region, and a second part (not shown) having another exposed region crossing the first part in a symmetrical manner. The laser diode portion 110 may include a first laser diode 111 for emitting an excitation beam toward the first part, and a second laser diode 112 for emitting an excitation beam toward the second part. With such a configuration, the excitation beam may be emitted toward the laser gain medium 120, and may be uniformly absorbed to the laser gain medium 120 in a symmetrical manner right and left. For an enhanced excitation uniformity, a doping concentration of the laser gain medium 120 may be changed, and the laser gain medium 120 may be partially doped.

The gain medium mounting portion 130 is formed to fix the laser gain medium 120. More specifically, the gain medium mounting portion 130 is configured to fix the laser gain medium 120 in a state where a region of the laser gain medium 120 to absorb an excitation beam emitted from the laser diode portion 110 has been exposed, such that the excitation beam is absorbed to the laser gain medium 120. And the gain medium mounting portion 130 is configured to receive and emit heat generated from the laser gain medium 120 to the outside, by an air cooling method. For this, the gain medium mounting portion 130 may be provided with radiating fins 132 formed on an outer surface thereof so as to increase a contact area with external air.

The gain medium mounting portion 130 may be provided with a gain medium supporting portion 134 for fixing two ends of the laser gain medium 120 so as to fix the laser gain medium 120 inserted into the gain medium mounting portion 130. A fixing screw insertion opening 135 for fixing the laser gain medium 120 inserted into a gain medium supporting portion 134 may be formed at the gain medium supporting portion 134.

One surface of the gain medium mounting portion 130 where the laser gain medium 120 is disposed, may solve decrease of an emission cross section of the laser gain medium 120 due to rapid conduction of heat, occurring as an excitation beam is absorbed. The gain medium mounting portion 130 may be formed of copper, aluminum, stainless, etc. with consideration of a thermal conductivity. A thermal grease or a material having an excellent thermal conductivity such as an indium foil may be installed between the laser gain medium 120 and the gain medium mounting portion 130, in order to facilitate a thermal conductivity of the laser gain medium 120 and the gain medium mounting portion 130.

The laser diode mounting portion 140 may be configured to fix the laser diode portion 110 so as to be toward the laser gain medium 120, and to receive and emit heat generated from the laser diode portion 110 to the outside by an air cooling method. For this, the laser diode mounting portion 140 may be provided with radiating fins 142 formed on an outer surface thereof so as to increase a contact area with external air. A wire groove 144, where a wire for supplying power to the laser diode portion 110 is disposed, may be provided at the laser diode mounting portion 140.

The gain medium mounting portion 130 may include a reflector 131.

The reflector 131 is configured to reflect an excitation beam emitted from the laser diode portion 110 toward the laser gain medium 120, and thus to absorb the excitation beam to the laser gain medium 120. More specifically, the reflector 131 is formed of a material from which an excitation beam having passed through the laser gain medium 120 can be reflected. And the reflector 131 is disposed close to the laser gain medium 120. With such a configuration, an excitation uniformity of the laser gain medium 120 may be enhanced.

The reflector 131 may be provided with a scattered reflection layer formed of a scattered reflection-processed material such that the excitation beam may be reflected in a diffused manner. The reflector 131 may be integrally formed with the gain medium mounting portion 130. That is, the reflector 131 may be formed on one surface of the gain medium mounting portion 130 where the laser gain medium 120 is mounted. In this case, the reflector 131 may be formed of a material by which the excitation beam can be reflected.

The reflector 131 may be processed to have a semi-circular shape, a quadrangular shape, a protruded shape, an oval shape, etc. according to an excitation characteristic. In order to enhance reflection efficiency of the excitation beam and to control a scattering angle, a spectralon or ceramic powder may be coated on the surface of the reflector 131.

The air cooling type laser diode pumped chamber 100 may further include a thermo-element 150.

The thermo-element 150 is configured to have temperature decrease on its one surface and to have temperature increase on its another surface opposite to the one surface when an electric current is applied thereto. And the thermo-element 150 is disposed such that the laser diode portion 110 and the laser gain medium 120 are positioned on the one surface, such that heat generated from the laser diode portion 110 and the laser gain medium 120 is cooled.

Heat accumulated on the gain medium mounting portion 130 is firstly emitted by external air, through the radiating fins 132 of the gain medium mounting portion. Then, the heat is conducted through a body of the gain medium mounting portion 130, thereby maintaining a constant temperature by the thermo-element 150. In this case, a hot surface of the thermo-element 150, i.e., the another surface of the thermo-element 150 may be disposed on a medium having a large thermal capacity, e.g., a heat tank (not shown) or additional cooling fins (not shown).

A fixing pin (not shown) may be installed on an upper end of the heat tank, such that the gain medium mounting portion 130 may be positioned on a cold surface of the thermo-element 150, i.e., the one surface of the thermo-element 150. Then, the fixing pin may be inserted into a fixing member insertion opening 136. For prevention of a motion of the gain medium mounting portion 130 due to an external force, a fixing screw (not shown) may be fitted into the fixing member insertion opening 136, thereby fixing the gain medium mounting portion 130.

Next, the laser diode mounting portion 140 may be provided with a laser diode fixing screw insertion opening 143 such that an excitation beam may be uniformly absorbed to the laser gain medium 120 as a slow axis direction of the laser diode portion 110 is made to be consistent with a lengthwise direction of the laser gain medium 120. A fixing screw (not shown) having a diameter of a predetermined size may be inserted into the laser diode fixing screw insertion opening 143, thereby tightly fixing the laser diode portion 110. The laser diode portion 110 contacts a laser diode mounting surface 140a processed to facilitate heat transfer. And a thermal grease or an indium foil, etc. may be installed at a contact surface between the laser diode portion 110 and the laser diode mounting surface 140a, for an enhanced thermal conductivity.

Heat generated by emission of an excitation beam from the laser diode portion 110 makes an excitation beam spectrum shift, thereby lowering an output energy of a laser. Thus, heat generated by emission of an excitation beam from the laser diode portion 110 is primarily emitted by convection, through the radiating fins 142 of the laser diode mounting portion 140. And the laser diode portion 110 is maintained at a constant temperature, through the thermo-element 150 disposed on a bottom surface of the laser diode mounting portion 140 connected to a laser diode heat transferring portion 141. This heat transfer to outside prevents a change of the excitation beam spectrum.

For facilitation of four-surface excitation, one laser diode mounting portion 140 where the laser diode portion 110 has been installed may be disposed on the heat tank by using a fixing pin, so as to cross another laser diode mounting portion 140 in a lengthwise direction. For a stable temperature of the laser diode portion 110, the fixing pin is preferably disposed with consideration of a position of the laser diode mounting portion 140 on the thermo-element 150, and a distance between the laser diode portion 110 and a center of the laser gain medium 120. In this case, the distance is implemented to enhance an excitation uniformity and to facilitate transfer of excitation energy. The laser diode mounting portion 140 may be disposed on the heat tank as a fixing pin is inserted into the fixing member insertion opening 145. For prevention of a motion of the laser diode mounting portion 140 due to an external force, a fixing screw may be fitted into the fixing member insertion opening 145, thereby stably fixing the laser diode mounting portion 140.

With such a structure, the present invention may have the following advantages.

More specifically, the structure of the present invention is provided with the gain medium mounting portion 130 and the laser diode mounting portion 140 which are cooled by an air cooling method, and the laser gain medium 120 is configured to generate laser beam by the laser diode portion 110 which emits an excitation beam towards a plurality of directions. Thus, the air cooling structure of the present invention can more reduce a volume and a weight of the air cooling type diode pumped chamber 100, than the conventional water cooling structure. Further, beam quality can be stably maintained, and excellent excitation efficiency can be implemented through multi-surface excitation.

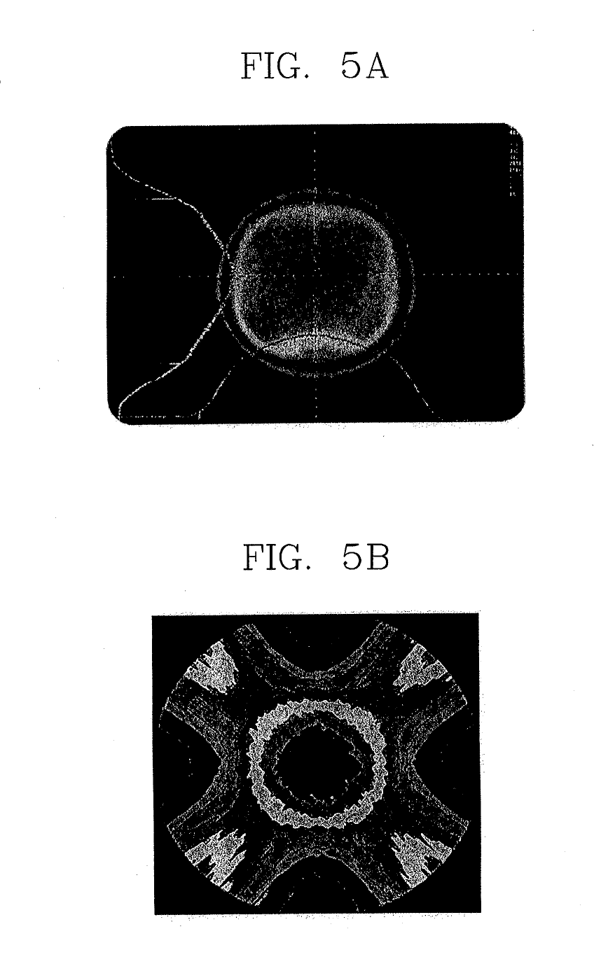

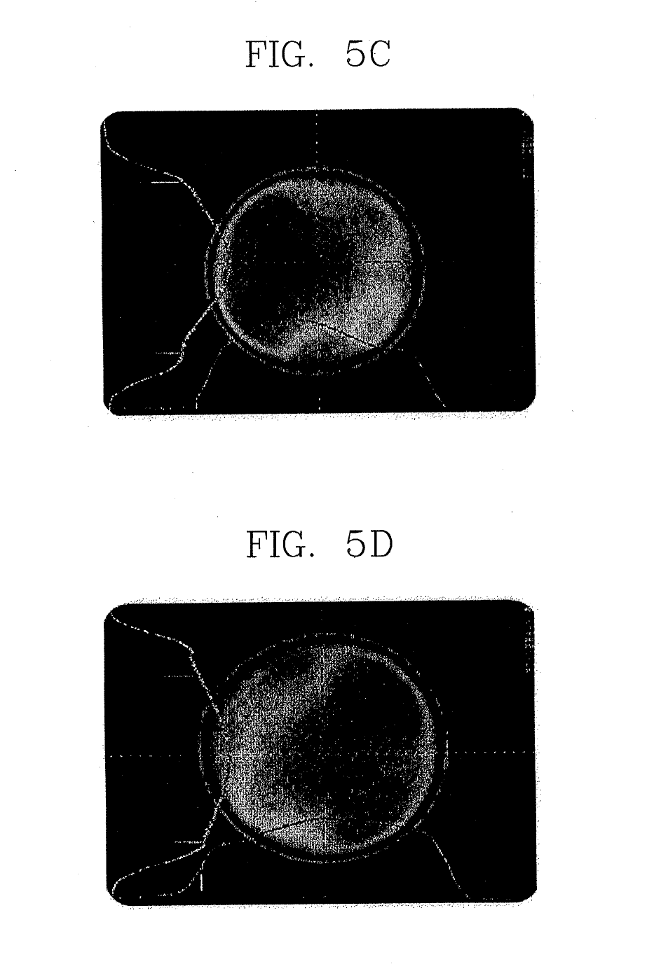

Hereinafter, distribution of an excitation beam absorbed during an excitation process by the air cooling type laser diode pumped chamber 100 shown in FIG. 1, will be explained with reference to FIGS. 5A to 5D.

FIG. 5A is a view illustrating distribution of an excitation beam absorbed by the laser gain medium 120 shown in FIG. 2, during four-surface excitation. FIG. 5B is a view illustrating distribution of a computer simulated excitation beam absorbed by the laser gain medium 120 shown in FIG. 2, during four-surface excitation. FIG. 5C is a view illustrating distribution of an excitation beam absorbed by the laser gain medium 120 shown in FIG. 2, during left two-surface excitation. FIG. 5D is a view illustrating distribution of an excitation beam absorbed by the laser gain medium 120 shown in FIG. 2, during right two-surface excitation.

FIGS. 5A to 5D illustrate distribution of an excitation beam obtained through left two-surface excitation and right two-surface excitation, by using the air cooling type laser diode pumped chamber 100 shown in FIG. 1. Referring to distribution of an excitation beam through left two-surface excitation shown in FIG. 5C and distribution of an excitation beam through right two-surface excitation shown in FIG. 5D, the excitation beam absorbed to an excitation position of the laser diode portion 110 is distributed in a concentrated manner.

In the present invention, four-surface excitation has been executed through left two-surface excitation and right two-surface excitation simultaneously performed in a crossing manner. Referring to the distributed state of the excitation beam shown in FIG. 5A, four-surface excitation by an air cooling method has been executed with a similar level to four-surface excitation by a water cooling method. This means that an obtained computer simulation for four-surface excitation shown in FIG. 5B is similar to an optimum computer simulation. During the computer simulation, a wavelength and a line width of the laser diode portion 110, a doping concentration of the laser gain medium 120, etc. may be selected for conditions of a high excitation uniformity. And a wavelength and a line width of the laser diode portion 110, and a doping concentration of the laser gain medium 120 may be changed according to a development purpose of a diode excitation solid-state laser.

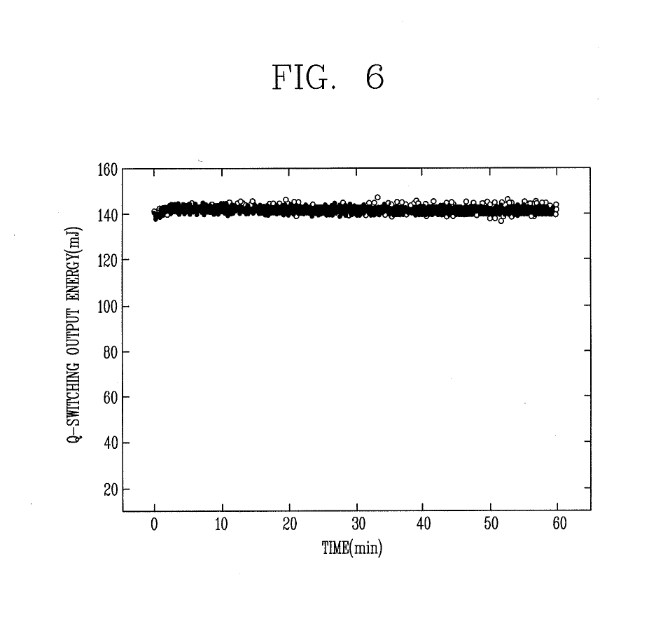

Hereinafter, an output energy of a laser, implemented by the air cooling type laser diode pumped chamber shown in FIG. 1, will be explained with reference to FIG. 6.

FIG. 6 is a graph illustrating an output energy of a laser formed by the air cooling type laser diode pumped chamber shown in FIG. 1.

FIG. 6 is a graph illustrating Q-switching output energy according to time, which is implemented by the air cooling type laser diode pumped chamber 100 shown in FIG. 1. In order to test performance of the air cooling type laser diode pumped chamber 100, a laser apparatus is simply constructed by inserting the pumped chamber 100 to a fabry-perot interferometer. In this case, an output energy of a laser has a deviation of approximate 1% with respect to an average output, which is similar to or slightly higher than a value obtained when a general water cooling type pumped chamber is used.

The present invention having such a structure may have the following advantages.

Firstly, the structure of the present invention is provided with the gain medium mounting portion and the laser diode mounting portion which are cooled by an air cooling method, and the laser gain medium is configured to generate laser beam by the laser diode portion which emits an excitation beam toward a plurality of directions. Thus, the present invention can more reduce a volume and a weight of the air cooling type diode pumped chamber, than the conventional water cooling type. Further, beam quality can be stably maintained, and excellent excitation efficiency can be implemented through multi-surface excitation.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An air cooling type laser diode pumped chamber, comprising:
a laser diode portion configured to emit an excitation beam toward a plurality of different directions;
a laser gain medium disposed to face the laser diode portion, so as to generate laser beam by absorbing the excitation beam emitted from the laser diode portion;
a gain medium mounting portion configured to fix the laser gain medium in a state where a region of the laser gain medium to absorb the excitation beam is exposed, and configured to receive and emit heat generated from the laser gain medium to the outside by an air cooling method; and
a laser diode mounting portion configured to fix the laser diode portion, and configured to emit heat generated from the laser diode portion to the outside by an air cooling method.

2. The air cooling type laser diode pumped chamber of claim 1, wherein the laser gain medium includes:
a first part having one exposed region; and
a second part having another exposed region crossing the first part in a symmetrical manner, and
wherein the laser diode portion includes:
a first laser diode configured to emit the excitation beam toward the first part; and
a second laser diode configured to emit the excitation beam toward the second part.

3. The air cooling type laser diode pumped chamber of claim 1, wherein the gain medium mounting portion includes a reflector configured to reflect the excitation beam emitted from the laser diode portion toward the laser gain medium, and thus to absorb the excitation beam to the laser gain medium, the reflector disposed close to the laser gain medium and formed of a material from which the excitation beam having passed through the laser gain medium can be reflected.

4. The air cooling type laser diode pumped chamber of claim 3, wherein the reflector is provided with a scattered reflection layer formed of a scattered reflection-processed material such that the excitation beam is reflected in a diffused manner.

5. The air cooling type laser diode pumped chamber of claim 1, further comprising a thermo-element configured to have temperature decrease on its one surface and to have temperature increase on its another surface when an electric current is applied thereto,
wherein the thermo-element is disposed such that the laser diode portion and the laser gain medium are positioned on the one surface, such that heat generated from the laser diode portion and the laser gain medium is cooled.

6. The air cooling type laser diode pumped chamber of claim 1, wherein at least one of the gain medium mounting portion and the laser diode mounting portion is provided with radiating fins formed on an outer surface thereof so as to increase a contact area with external air.
